(19) United States
(12) Patent Application Publication
(10) Pub. No.: US 2012/0024909 A1
(43) Pub. Date: Feb. 2, 2012

(54) DISPENSER

(75) Inventor: Lamberto Carta, Pescara (IT)

(73) Assignee: EMSAR S.p.A., San Giovanni Teatino (CH) (IT)

(21) Appl. No.: 13/260,784

(22) PCT Filed: Mar. 30, 2010
(86) PCT No.: PCT/IT2010/000136

§ 371 Date: Sep. 28, 2011

(30) Foreign Application Priority Data
Apr. 2, 2009 (IT) RM2009A000154

(51) Int. Cl. G01F 11/00

(52) U.S. Cl. 222/321.9

(57) ABSTRACT

A dispenser includes a hollow containment body (2) able to be inserted in a bottle, having a hole (19) able to be positioned to face the interior of the bottle, a ring nut (14) able to be screwed on the neck of the bottle and having an annular shoulder (15) associated to, and covering, an annular lip (16) of the containment body (2) to mutually fasten ring nut (14) and containment body (2), at least one meatus (18) obtained in the containment body (2) to place selectively in fluid communication an inlet for air from the outside environment with the hole (19) in the containment body (2). The dispenser further includes spacer elements (20) active between the annular shoulder (15) and the annular lip (16) to define the air inlet passage.

### TECHNICAL FIELD

The present invention relates to a dispenser, i.e. a dosing device able to be applied to the neck of a bottle to dispense the liquid contained therein.

### BACKGROUND ART

In particular, the present invention relates to a dispenser of the type comprising a containment body with substantially axial-symmetric geometry, internally hollow and able to be inserted in the neck of a bottle.

The containment body is fastened to a threaded ring nut which is screwed on to the neck of a bottle.

In particular, the containment body comprises an annular portion facing an annular portion of the ring nut and fastened thereto.

The containment body is provided in a first end with an orifice for the entry of the liquid product present in the bottle. Said orifice is opened or closed by a ball free to slide within the containment body, in particular within a dosing chamber included therein.

The dosing chamber is defined by the space present between a piston, guided by an internally hollow stem, able to slide within the containment body and the bottom portion (where the orifice is positioned) of the containment body.

Between piston and stem are present means for opening and closing the inner cavity of the stem in such a way as selectively to place in fluid communication the interior of the stem with the dosing chamber.

The stem is guided in its travel by a retaining ring, integral with the containment body, which also serves the abutment function for the travel of the piston.

In other words, the retaining ring defines the upper limit of the dosing chamber, preventing the piston from being able to exit from the dosing chamber itself.

When the piston creates an overpressure within the dosing chamber, the cavity of the stem is in fluid communication with the dosing chamber and the fluid present in the dosing chamber rises along the stem and is dispensed by a spout associated therewith.

In this configuration, the ball is lowered and occludes the aforementioned orifice because of the overpressure in the dosing chamber.

When the piston creates a vacuum within the dosing chamber the cavity of the stem is not in fluid communication with the dosing chamber and fluid is moved from the bottle into the dosing chamber.

In this configuration, the ball is raised and leaves open the aforementioned orifice because of the vacuum in the dosing chamber.

In this type of dispenser, the sliding of the piston within the containment body takes place contrasting the action of a spring whose function is to maintain the piston in raised position.

In particular, exercising a compression action on the stem, the piston slides within the dosing chamber, reducing its dimensions and hence creating an overpressure within it.

Ceasing the compression action on the stem, the aforementioned spring brings the piston back to the raised position, expanding the dimensions of the dosing chamber and hence creating a vacuum therein.

The pressure action on the stem is exercised on the dispensing spout positioned at the upper end of the stem and in fluid communication therewith to dispense the liquid contained in the bottle into the external environment.

Clearly, at every dispensing operation a volume of air equal to the dispensed liquid must enter into the bottle to maintain a pressure equilibrium between the bottle interior and the external atmosphere.

For this purpose, in prior art dispensers between the fastening ring nut and the dispensing spout that emerges therefrom there is a fluid blow-by, i.e. an inlet passage for the air, so that air from the outside environment can flow into meatuses created within the containment body.

In particular, said meatuses ensure that the air that blows by between spout and ring nut can reach a hole obtained on the outer surface of the containment body located within the bottle.

Said meatuses place in fluid communication the external environment with the aforementioned hole when the piston is in the lowered position, i.e. when the piston is performing its rising action within the dosing chamber.

In this way, the liquid aspirated by the bottle in the dosing chamber is replaced by air injected into the bottle.

When the piston in raised position, the meatuses occlude the fluid communication between external environment (i.e. between the air inlet passage) the internal environment of the bottle (i.e. the hole obtained in the containment body).

The prior art dispensers described above present some drawbacks.

In particular, in conditions of heavy water flow, e.g. under a shower, a film of water is created that coats the upper part of the dispenser (i.e. the part bearing the spout) directly exposed to the flowing water.

Therefore, when the dispenser is operated, through the blow-by gap between spout and ring nut, in addition to air, water is also injected into the containment body.

Water enters into the containment body follows the same path as air and, through the aforementioned meatuses, it reaches the interior of the bottle where it mixes with the liquid contained therein.

This causes a watering-down of the liquid contained in the bottle which, following prolonged uses of the dispenser, can be heavy and hence unacceptable.

### DISCLOSURE OF INVENTION

In this context; the technical task at the basis of the present invention is to propose a dispense that overcomes the aforementioned drawbacks of the prior art.

In particular, the object of the present invention is to make available a dispenser that prevents a heavy watering-down of the liquid contained in the bottle even when used under flowing water.

The specified technical task and the object specified are substantially achieved by a dispenser, comprising the technical characteristics exposed in one or more of the appended claims.

### DESCRIPTION OF THE DRAWINGS

Further characteristics and advantages of the present invention shall become more readily apparent from the indicative, and therefore not limiting, description of a preferred but not exclusive embodiment of a dispenser, as illustrated in the accompanying drawings in which:

FIG. 1 shows a perspective, partially sectioned view of a dispenser in accordance with the present invention in a first operating configuration;

FIG. 2 is an enlargement of some details of the dispenser of FIG. 1;

FIG. 3 shows a perspective, partially sectioned view of the dispenser of FIG. 1 in a second operating configuration.

### DESCRIPTION OF THE ILLUSTRATIVE EMBODIMENT

With reference to the accompanying drawings, a dispenser in accordance with the present invention is indicated with the number 1.

The dispenser 1 comprises a hollowing containment body 2 able to be inserted in a bottle.

The containment body 2 has axial-symmetric geometry and it comprises an upper portion 3 and a bottom portion 4.

The upper portion 3 of the containment body 2 is open and its function is to enable the insertion into the hollow body 2 of the elements (described below) which comprise the dispenser.

The bottom portion 4 is provided with an orifice 5 through which the liquid contained in the bottle enters the containment body 2.

The orifice 5 is engaged by a ball 5a whose function is to open or close the orifice 5 in ways that will be clarified farther on.

The containment body 2 is substantially shaped as a funnel.

In particular, the containment body 2 comprises a first section 2a that develops starting from the upper portion 3 towards the bottom portion 4, and a second section 2b positioned underneath the first section 2a.

The second section 2b defines a dosing chamber 6 for the dispenser 1.

Underneath the dosing chamber 6 develops a third section 2c from which the orifice 5 extends.

The three aforementioned sections have mutually different transverse dimensions, in such a way as to define the aforesaid funnel configuration of the containment body 2.

In particular, the second section 2b, the one defining the dosing chamber 6, is substantially cylindrical.

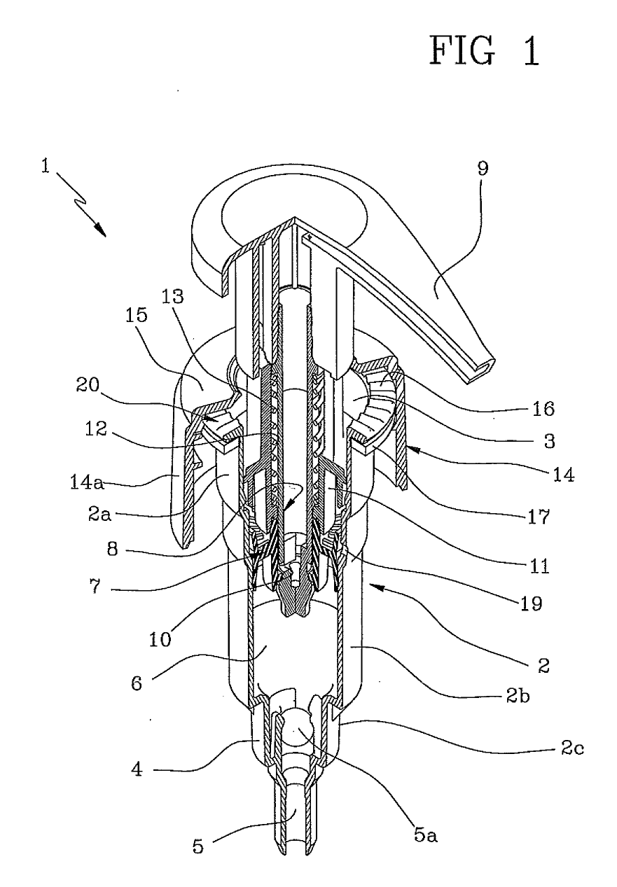

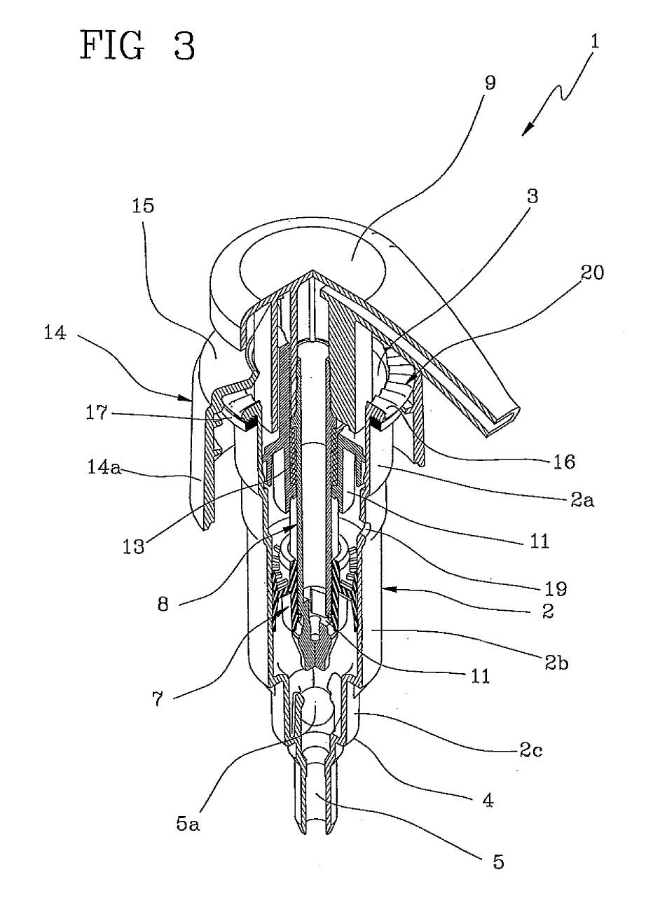

Within the hollow body 2 is provided a piston 7 movable between a raised position (illustrated in FIG. 1) and a lowered position (illustrated in FIG. 3).

The piston 7 comprises an outer surface able to contact the inner wall of the second portion 2b of the hollow body 2.

The outer surface 7 of the piston 6 slides within the dosing chamber 6 between the aforementioned raised position in which the volume of the dosing chamber is greatest, and the aforementioned lowered position, in which the volume of the dosing chamber 6 is smallest.

The outer surface of the piston 7 slides providing fluid tightness along the inner wall of the second portion, in such a way that liquid present in the dosing chamber cannot escape through the sliding coupling between piston 7 and dosing chamber 6.

The dispenser 1 further comprises a hollow stem 8 able to slide within the containment body 2 between a raised position (FIG. 1) and a lowered position (FIG. 3).

The stem 8 commands the operation of the piston 7, i.e. it actuates it within the dosing chamber 6.

The stem 8 also serves the function of transferring, through its cavity, liquid present inside the dosing chamber 6 to a spout 9 that dispenses the liquid to a user. In particular, the stem 8 comprises at least one window 10, preferably two mutually opposite windows, selectively to place in fluid communication the cavity of the stem 7 with the interior of the containment body 2, in particular with the dosing chamber 6.

The windows 10 are obtained on the lateral wall of the stem 8.

The stem 8 is partially able to slide relative to the piston 7 in such a way that the window 10 is occluded or freed by the piston 7.

In particular, the stem 8 is inserted in a through hole of the piston 7.

The stem is free to slide within the through hole by such a quantity as to make the window 10 emerge within the dosing chamber 6.

The terminal part of the stem 8 is therefore closed, in such a way that the liquid in the dosing chamber 6 can enter the cavity of the stem 8 only through the window 10.

In the preferred embodiment, the relative motion between stem 8 and piston 7 is delimited by upper and lower abutments positioned on the stem 8.

To guide the stem 8 in its travel within the containment body 2, the dispenser 1 comprises a retaining ring 11 integral with the containment body 2 and inserted therein.

The retaining ring 11 is positioned in the first section 2a of the body 2 and it has a hole 12 for the passage of the stem 8.

The dispenser 1 comprises elastic means 13 to contrast the free sliding of the stem (and hence of the piston) within the containment body 2.

Said elastic means, preferably constituted by a spring, can be active between a lower end portion of the stem 8 and the bottom portion 4 of the containment body or between the retaining ring 11 and the stem 8 (the latter configuration is the one shown in the accompanying figures).

It should be noted that the latter configuration prevents the spring 13 from being in contact with the liquid contained in the dosing chamber 6.

The spring 13 is positioned concentrically to the stem 8 and externally thereto.

Acting on the spout 9, in particular pressing it, the stem 8 and the piston 7 translated within the dosing chamber 6.

In a first phase of said translation, the piston 7 remains motionless both because of the friction of the wall of the piston with the wall of the dosing chamber 6, and as a result of the overpressure that is generated in the liquid contained in the dosing chamber because of the reduction in volume of said chamber.

In this phase the stem 8 translates relative to the piston 7 facing the window 10 (situated at the lower end of the stem 8).

The subsequent travel of the stem 8 drives with it the piston 7 determining a compression of the liquid present in the dosing chamber 6 which flows through the window 10 and hence through the spout 9 until it flows out to the exterior (operating configuration shown in FIG. 3).

As a result of the release of the spout 9 by the user, the entire system returns to the resting position (shown in FIG. 1) thanks to the spring 13.

During the rising phase, the stem 8 moves before the piston 7 (held by the friction with the walls of the dosing chamber 6) thereby closing the window 10.

In this way, the liquid present in the stem 8 and in the spout 9 is prevented from being aspirated into the dosing chamber 6 again.

The translation during the return travel of the piston 7 in the dosing chamber 6 creates a depression inside the dosing chamber 6 which determines the aspiration of liquid through the orifice 5 of the containment body 2.

As mentioned above, the containment body 2 can be inserted into the bottle.

To hold and fasten the containment body 2 within the bottle, a threaded ring nut 14, able to be screwed on the neck of the bottle, is provided.

The ring nut 14 comprises an annular shoulder 15 associated with, and covering, an annular lip 16 of the containment body 2.

The lip 16 of the containment body 2 is positioned in the upper portion 3 of the stem and it surrounds the upper opening of the containment body 2.

The annular shoulder 15 bears on the upper surface of the lip 16 and it compresses the lip 16 against the edge of the neck of the bottle.

To prevent the liquid present in the bottle from escaping accidentally, a gasket 17 is positioned between the annular lip 16 and the edge of the neck of the bottle.

The ring nut 14 further comprises a hole to allow the passage and the sliding of the stem 8 and of the spout 9.

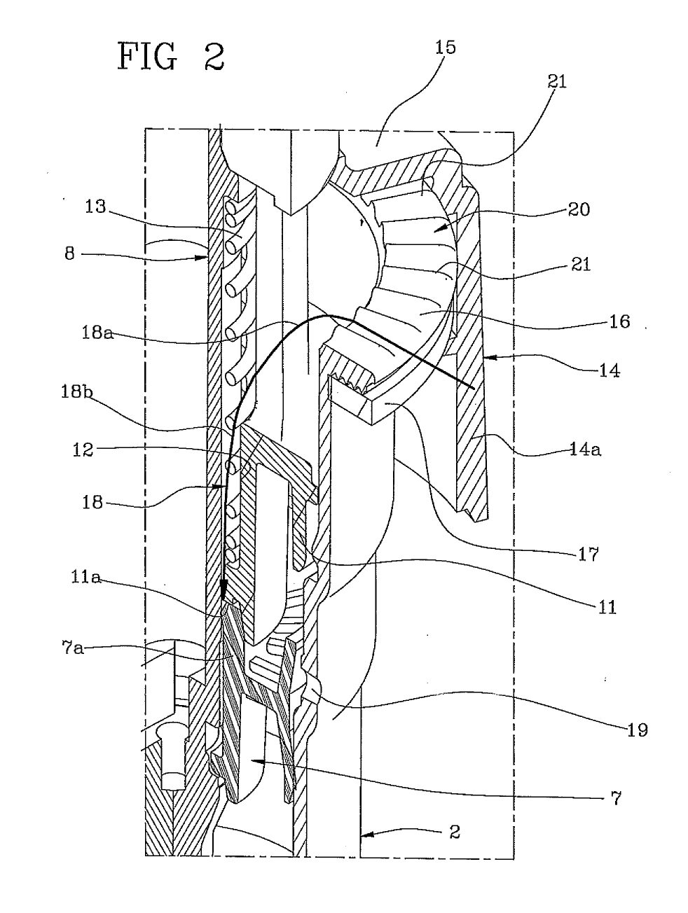

At each dispensing operation, a volume of air equal to the dispensed liquid enters into the bottle through a meatus 18 that develops inside the containment body 2 and that is placed in fluid communication with a hole 19 drilled on the containment body 2 and facing the interior of the bottle (as illustrated by the arrow in FIG. 2).

The meatus 18 is also in fluid communication with an inlet for the passage of air from the outside environment.

Preferably, the meatus 18 develops starting from a region positioned above the retaining ring 11, i.e. between the retaining ring 11 and the upper portion 3 of the containment body 2, to a region positioned underneath the retaining ring 11, i.e. between retaining ring 11 and piston 7.

The hole 19 in the containment body 2 is positioned between the retaining ring 11 and the piston 7.

The hole 19 is positioned underneath the ring 11 and above the piston 7.

In particular, the meatus 18 comprises a first portion 18a positioned in the first section 2a of the containment body 2.

Said first portion 2a is only partially engaged by the retaining ring 11.

The meatus 18 further comprises a second portion 18b defined between the stem 8 and the retaining ring 11.

It should be noted that the stem 8 slides without providing fluid tightness within the retaining ring 11.

The retaining ring 11 is coupled in fluid tightness with the inner wall of the containment body 2.

The meatus 18 further comprises a third portion 18c that develops between the piston 7 and the retaining ring 11.

This third portion directly faces the hole 19 in the containment body 2.

When the dispenser 1 is in resting condition (i.e. when the spout 9 is not pressed), the piston 7 is engaged in fluid tightness with the retaining ring 11, interrupting the meatus 18 and hence preventing air from entering into the bottle (as illustrated by the arrow in FIG. 2).

In particular, an upper portion 7a of the piston 7 is engaged in fluid tightness in an undercut 11a of the retaining ring 11.

When the dispenser is activated (i.e. when the stem 8 completes a compression travel of the piston 7 or a rising travel thereof), the fluid tight engagement between retaining ring 11 and piston 7 is no longer present.

Advantageously, the dispenser comprises distancing means 20 between the annular shoulder 15 and the annular lip 16 to define the aforementioned air inlet passage within the containment body.

The spacing means 20 prevent the annular lip 16 and the annular shoulder 15 from being superposed on each other in fluid tight fashion.

In this way, the entry of water is minimized, in case of use of the dispenser under flowing water, because the inlet passage that places in fluid communication the meatus 18 with the outside environment is not directly exposed to the flowing water.

It should be noted that the ring nut 14 covers the annular lip 16 of the containment body 2.

It should also be noted that the screwed-on coupling between ring nut 14 and neck of the bottle, which takes place through a threaded cylindrical portion 14a of the ring nut that develops starting from the shoulder 15 and perpendicularly thereto, is not a fluid-tight coupling.

Therefore, air from the outside environment rises along said screwed-on coupling and reaches the inlet passage.

Advantageously, the dispenser 1 further comprises fluid-tightness means active between the ring nut 14 and the dispensing spout 9, in such a way that in the gap between the hole of the ring nut and the spout 9 (which slides within it) no water can flow, which would enter into the containment body 2.

The fluid-tightness means (not shown) can, for example, be a gasket fitted in the hole of the ring nut 14, a bellows that extends between the ring nut 14 and the spout 9, or any other device suitable for the purpose.

In the preferred embodiment, illustrated in the accompanying drawings, the spacing means 20 are provided on the annular lip 16 of the containment body 2.

In an alternative embodiment, the spacing means 20 are provided on the annular shoulder 15 of the ring nut 14.

In an additional alternative embodiment, the spacing means 20 are provided both on the annular lip 16 of the containment body 2 and on the annular shoulder 15 of the ring nut 14.

Preferably, the spacing means 20 comprise at least one projection 21 that develops from the annular lip 16 of the containment body 2 towards the annular shoulder 15.

Preferably, the projections 21 are a plurality, mutually equidistant.

In particular, the projections 21 are positioned radially on the lip 16 and/or on the shoulder 15 and they are ideally convergent at the axis of symmetry of the containment body 2.

The air passages are then defined between two consecutive projections 21 delimited superiorly and inferiorly respectively by the shoulder 15 of the ring nut 14 and by the lip 16 of the containment body 2.

It should be noted that if the projections 21 are positioned both on the lip 16 and on the shoulder 15, in such a way as not completely to occlude the air passages, the projections 21 obtain the effect of preventing the rotation of the containment body 2 relative to the ring nut 14.

The projections 21 of the lip 16 are inserted into the projections 21 of the shoulder 15 serving as anti-rotational elements.

In an embodiment that is not illustrated, the projections 21 are saw tooth shaped.

In this way, it is possible to achieve a coupling between ring nut 14 and containment body 2 such as to allow the mutual rotation of the two elements only in one direction.

The invention achieves the proposed object.

The spacing means 20 prevent the annular lip 16 and the annular shoulder 15 from being superposed on each other in fluid tight fashion.

In this way, the entry of water is minimized, in case of use of the dispenser under flowing water, because the inlet passage that places in fluid communication the meatus 18 with the outside environment is not directly exposed to the flowing water.

1. Dispenser comprising a hollow containment body (2) able to be inserted in a bottle, comprising a hole (19) able to be positioned to face the interior of said bottle and an orifice (5) for drawing liquid from said bottle, a ring nut (14) able to be screwed on the neck of said bottle, said ring nut (14) comprising an annular shoulder (15) associated to, and covering, an annular lip (16) of said containment body (2) to mutually fasten ring nut (14) and containment body (2), said dispenser further comprising a piston (7) able to slide within said containment body (2) between a raised position and a lowered position, a hollow stem (8) able to slide within said containment body (2), associated to a dispensing spout (9) to command the actuation of said piston (7) and dispense fluid contained in said bottle, at least one meatus (18) obtained in said containment body (2) to place selectively in fluid communication an inlet for air from the outside environment with the hold (19) in said containment body (2); characterised in that it comprises spacer means (20) active between said annular shoulder (15) and said annular lip (16) to define said air inlet passage.

2. Dispenser as claimed in claim 1 comprising fluid-tight means active between said ring nut (14) and said dispensing spout (9).

3. Dispenser as claimed in claim 1 wherein said spacer means (20) are provided on said annular lip (16) of said containment body (2).

4. Dispenser as claimed in claim 3 wherein said spacer means (20) comprise at least one projection (21) that develops from said annular lip (16) of the containment body (2) towards said annular shoulder (15).

5. Dispenser as claimed in claim 4 wherein said spacer means (20) comprise a plurality of mutually equidistant projections (21).

6. Dispenser as claimed in claim 5 wherein said spacer means (20) further comprise a plurality of projections (21) positioned on the annular shoulder (15) of the ring nut (14).

7. Dispenser as claimed in claim 1 wherein said spacer means (20) comprise a plurality of projections (21) positioned on the annular shoulder (15) of the ring nut (14).

8. Dispenser as claimed in claim 6 wherein said projections (21) on the shoulder (15) of the ring nut (14) and on the lip (16) of the containment body (2) are saw-tooth shaped.

9. Dispenser as claimed in claim 5 wherein each air passage is defined between two consecutive projections (21), the annular shoulder (15) of the ring nut (14) and the lip (16) of the containment body (2).

10. Dispenser as claimed in claim 1 comprising a retaining ring (11) fastened within the containment body (2) within which slides said stem (8); said meatus (18) being at least partly obtained between said retaining ring (11) and said stem (8).

11. Dispenser as claimed in claim 9 wherein said retaining ring (11) is positioned between said hole (19) in the containment body (2) and said air passage.

12. Dispenser as claimed in claim 2 wherein said spacer means (20) are provided on said annular lip (16) of said containment body (2).

13. Dispenser as claimed in claim 12 wherein said spacer means (20) comprise at least one projection (21) that develops from said annular lip (16) of the containment body (2) towards said annular shoulder (15).

14. Dispenser as claimed in claim 6 wherein each air passage is defined between two consecutive projections (21), the annular shoulder (15) of the ring nut (14) and the lip (16) of the containment body (2).

15. Dispenser as claimed in claim 7 wherein each air passage is defined between two consecutive projections (21), the annular shoulder (15) of the ring nut (14) and the lip (16) of the containment body (2).

16. Dispenser as claimed in claim 8 wherein each air passage is defined between two consecutive projections (21), the annular shoulder (15) of the ring nut (14) and the lip (16) of the containment body (2).
